(19) United States
(12) Patent Application Publication
(10) Pub. No.: US 2008/0308596 A1
(43) Pub. Date: Dec. 18, 2008

(54) Stapling Device

(75) Inventor: Jeremy Gardner, Berks (GB)

Correspondence Address: MICHAEL BEST & FRIEDRICH LLP, 100 EAST WISCONSIN AVENUE, SUITE 3300, MILWAUKEE, WI, 53202, US

(73) Assignee: ACCO UK LIMITED, Aylesbury, Bucks (GB)

(21) Appl. No.: 11/994,553

(22) PCT Filed: Jul. 5, 2006
(86) PCT No.: PCT/GB2006/002487

§ 371 Date: Jun. 3, 2008

(30) Foreign Application Priority Data
Jul. 6, 2005 (GB) 0513885.4

(51) Int. Cl. B25C 5/06

(52) U.S. Cl. 227/120

(57) ABSTRACT

The present invention relates to an improved stapling device. It can be frustrating to attempt to interconnect pieces of paper with a stapler and find that the attempt fails without prior warning, because the staple magazine is empty. The present invention provides a conveniently located visual representation of the number of staples remaining in the staple magazine.

The present invention relates to a stapling device.

Stapling devices, or “staplers” as they are more commonly known, are widely used to eject staples through two or more sheets of paper so as to hold the sheets against one another. A typical stapler comprises the following parts:
a base including an anvil,
a staple magazine configured to receive a strip of staples and having an ejection opening positioned, in use, above the anvil,
a staple feeder biased towards the ejection opening so as to bear against the end of a strip of staples in the magazine and urge them towards the ejection opening in the staple magazine, and
an actuating arm pivotally connected to the base, the actuating arm carrying an ejector blade.

The actuating arm may be moved pivotally so that an ejector blade contacts the first staple in the strip of staples, which is aligned with the ejection opening, the staple thus being ejected through the ejection opening. The arms of the staple may pass through sheets of paper to be interconnected, and will then engage the anvil carried by the base to be clinched.

When a stapler is ready for use, or is in use, the strip of staples is held within the stapler and may either not be visible at all externally by a person using the stapler, or may not be conveniently visible. It can be frustrating to attempt to interconnect pieces of paper with a stapler only to find that the attempt fails, without prior warning, because the staple magazine is empty.

Some staplers which are currently available have a viewing aperture at the side of the staple magazine, typically near to the ejection opening, to allow a user to see whether staples are present or not. Other staplers have a staple feeder of a contrasting colour such as red which, as the strip of staples depletes and becomes very short, becomes visible through a viewing aperture in the side of the staple magazine. Both of these currently available staplers suffer from inconvenient disadvantages. Firstly, any aperture in the side of the staple magazine can only be viewed by looking at the stapler from the side. A stapler is usually left sitting on a desk on its base, when not in active use, and so a user picking up a stapler from a desk will look most naturally at the top side of the actuating arm. It would take separate thought and action to tilt the stapler to view the aperture in the staple magazine at the side of the stapler. Furthermore, when in use, a user's hand is often placed around the forward part of the stapler, away from the pivotal connection between the actuating arm and the base, and therefore the aperture in the staple magazine is covered by the users hand.

An object of the present invention is to provide an improved stapling device.

According to a first aspect the present invention provides a stapling device comprising

a staple magazine configured to receive a strip of staples and having an ejection opening,
a staple feeder biased towards the ejection opening so as to bear against an end of a strip of staples in the magazine and urge the strip towards the ejection opening, the feeder thus being configured to move towards the ejection opening, under said bias, as the number of staples in the strip depletes,
the device further comprising an indicator tape attached to the staple feeder and having indicia, wherein the indicator tape is configured to allow movement of the indicia past a viewing area to provide a visual indication representative of the number of staples remaining in the staple magazine.

Preferably the indicator tape is biased away from the ejection opening, under a force which is weaker than the force acting to bias the feeder towards the ejection opening.

Advantageously the indicator tape is biased by a spring.

Conveniently one end of the indicator tape is wound onto a reel.

Preferably the indicator tape is biased via a clock spring.

Advantageously the reel is biased by said spring in a direction effective to wind in the indicator tape.

Conveniently the indicator tape passes around one or more pulleys.

Preferably the viewing area is defined by a window in the stapling device.

Advantageously the window is located in an actuating arm of the stapling device.

Conveniently the indicia comprise portions of colour on the indicator tape.

Preferably the indicator tape is made from plastics.

Alternatively the indicator tape is made from maleable metal.

Advantageously the indicator tape is elastically deformable.

In order that the invention may be more readily understood, and so that further features thereof may be appreciated, an embodiment of the present invention will now be described, by way of example, with reference to the accompanying drawings in which:

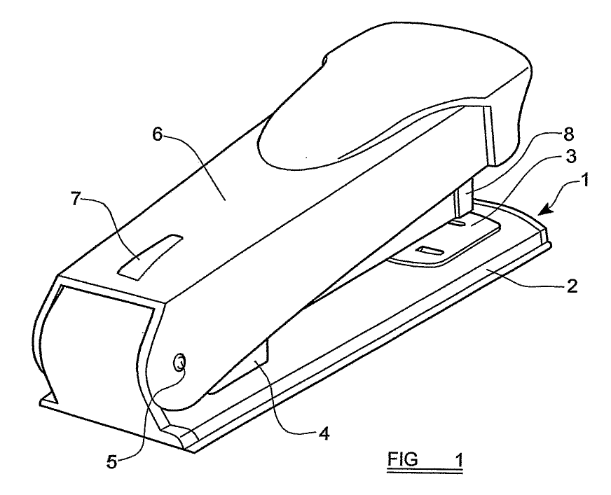

FIG. 1 is a perspective view from the back and one side of a stapling device in accordance with the invention;

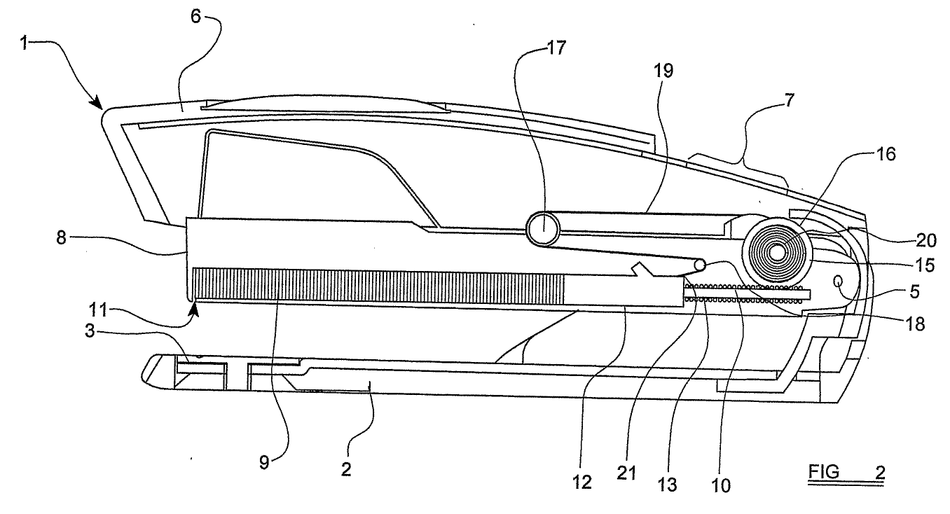

FIG. 2 is a longitudinal cross-sectional view through the stapling device of FIG. 1, illustrated from the other side, showing the device loaded with a strip of staples;

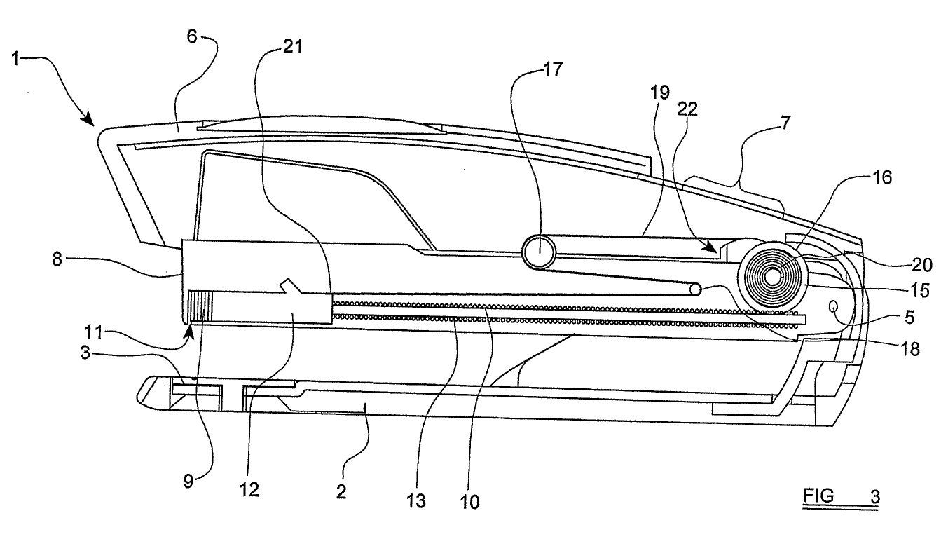

FIG. 3 is a longitudinal cross-sectional view corresponding generally to FIG. 2, showing the device loaded with only a few staples; and

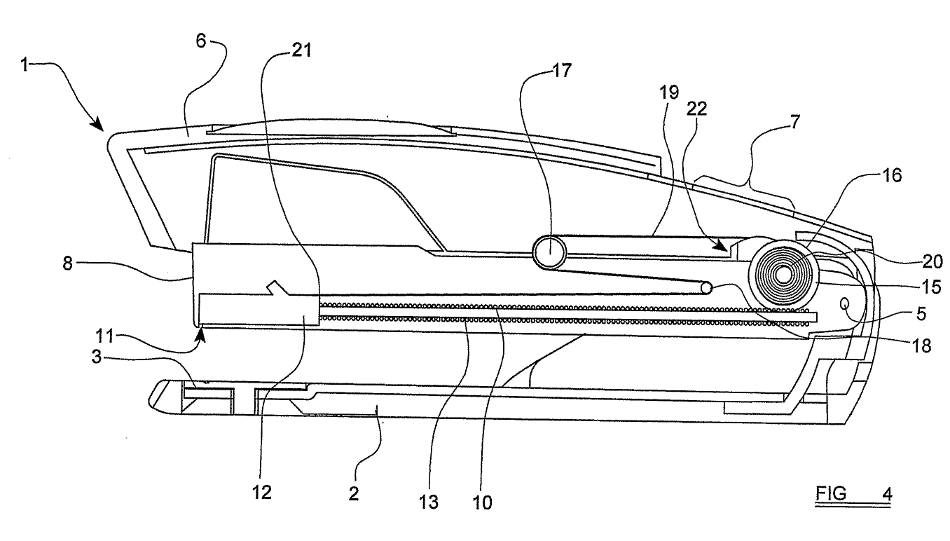

FIG. 4 is a longitudinal cross-sectional view corresponding generally to FIG. 3, showing the device empty of staples.

Referring initially to FIG. 1 of the accompanying drawings, a stapling device 1 is shown which comprises a substantially rigid base 2 which carries, at its forward end, an anvil 3. At the rear of the base 2, two up-standing spaced-apart supports 4 are provided (only one visible). The supports 4 are associated with a transversely extending pivot bar 5 which pivotally supports an actuating arm 6. A conveniently located viewing area defined by a window 7 is provided in the rear part of the actuating arm 6 for a purpose which will become clear hereinafter. The actuating arm 6 is formed from an inverted “U”-shaped channel and, received within the actuating arm, is a staple magazine 8, in a manner known per se.

Referring to FIG. 2 of the accompanying drawings, the stapling device 1 of FIG. 1 is shown in cross-section, and is loaded with a strip of staples 9. The staple magazine 8 takes the form of an upwardly open elongate channel having a feeder rod 10 centrally and longitudinally mounted within the channel and in these respects is of generally conventional form.

The staple magazine 8 has a downwardly directed ejection opening 11, shaped as a slot which is located at the end of the magazine 8 remote from the pivot bar 5 and, in use, is located above the anvil 3.

A staple feeder 12 is mounted for sliding movement longitudinally within the staple magazine 8 along the feeder rod 10. The feeder 12 is biased towards the ejection opening 11 by a helically wound compression 13 spring extending over the feeder rod 10. The helically wound compression spring 13 is fixed at its end remote from the ejection opening 11 and in the region of the pivot bar 5. The other end of the helically wound compression spring 13 is tethered or otherwise attached to the staple feeder 12. As such, the spring 13 provides a biasing force on the feeder 12 effective to urge it along the magazine 8 towards the ejection opening 11.

The strip of staples 9 sits in the channel of the staple magazine 8 between the forward end and the feeder 12. The strip 14 is urged forwardly along the channel of the staple magazine 8 towards the ejection opening 11 by the staple feeder 12, such that the first staple in the strip of staples 14 is positioned above the ejection opening 11 in readiness for actuation of the stapling device 1.

A reel 15 is provided at the rear of the stapling device 1 between the sides of the channel of the staple magazine 8, the reel 15 being mounted for rotation about a substantially horizontal axis. The reel 15 comprises a spirally wound torsion spring 16 of the type generally known as a “clock spring”. The clock spring 16 biases the reel 15 so as cause it to rotate in a clockwise sense, in the configuration illustrated in FIG. 2.

The stapling device 1 also has a first turning pulley 17 located above and part way along the staple magazine 8, and second turning pulley 18 located towards the rear of the device 1 in the general region of the reel 15.

An elongate flexible indicator tape 19 is provided, one end 20 of which is attached to and wound on the reel 15. The tape 19 extends from the reel 15, below the viewing area defined by the window, 7 towards the front region of the stapling device 1 and passes around the first pulley 17. From here, the tape 19 extends rearwardly and runs around the second pulley 18, whereupon the tape 19 extends towards the feeder 12. The free end 21 of the tape 19 is secured to the feeder 12.

It will be appreciated that because the tape 19 is wound on the rotatably biased reel 15, then the biasing clock spring 16 serves to bias the reel 15 in a winding-in direction effective to wind the tape 19 onto the reel 15. The biasing force acting on the indicator tape 19 which is provided by the clock spring 16 is weaker than the biasing force provided by the compression spring 13 on the staple feeder 12.

The indicator tape 19 has indicia, which in this embodiment, take the form of regions having contrasting colours. The colour of the region of the indicator tape 19 located below the window 7 is visible through the window 7. A first, forward-most portion of the indicator tape 19 is coloured green which gives a visual representation that the staple magazine 8 is loaded with a strip of staples 9 when this portion is visible through the window 7. A second, rearward, portion of the indicator tape 19 is coloured red. When the stapling device 1 is sufficiently loaded with staples, the red portion of the indicator tape 19 is wound-in on the reel 15, and so will not be visible through the window 7.

FIG. 3 shows the same stapling device 1 after a number of actuations such that the strip of staples 9 has become depleted and has fewer staples. Consequently, staple feeder 12 has changed position with respect to FIG. 2 by sliding along the channel of the staple magazine 8 closer to the ejection slot 11 under the force of the helically wound compression spring 13. Furthermore a longer length of indicator tape 19 has become paid-out from the reel 15. The notational line 22, shown part way along the indicator tape 19, marks the change in colour of the indicator tape 19 from green to red. The green portion extends from point 22 towards the end 21 of the tape 19 which is attached to the staple feeder 12, whilst the red portion extends from point 22 towards the end 20 of the tape 19 wound on the reel 15. In this configuration the portion of indicator tape 19 visible through the window 7 in the actuating arm 6 is part-green and part-red. This provides a visual representation that there are only a few staples remaining and that the strip of staples 9 is largely depleted. Consequently, with further actuations, the staple magazine 8 will soon be empty and the staple magazine 8 will need to be refilled if use of the stapling device is to continue.

Further actuations of the stapling device 1 will still further deplete the strip of staples 9. This will cause the staple feeder 12 to slide further along the staple magazine 8, under the force of the helically wound compression spring 13. The indicator tape 19 will be paid out further from the reel 15 such that the green part of the indicator tape 19 visible through the window 7 in the actuating arm 6 becomes smaller whilst the red part grows larger.

FIG. 4 shows the same stapling device 1 after further actuations such that the staple magazine 8 is empty of staples. It will be noted that in comparison with FIG. 3, the notational line 22 has moved with respect to the window 7 as further indicator tape 19 is paid-out from the reel 15. In this configuration the part of the indicator tape 19 visible through the window 7 in the actuating arm 6 appears entirely red. This provides a clear indication to a user that the staple magazine 8 is empty and that an attempt to interconnect sheets of paper by actuating the stapling device 1 will fail.

As will be appreciated by persons skilled in the art, the arrangement of the indicator tape within the stapler could vary from that shown in FIGS. 2, 3 and 4, whilst still falling within the scope of the present invention. For example, the turning pulleys 17, 18 could be located differently. The indicator tape could also be arranged so that fewer pulleys or no pulleys may be used, or alternatively more pulleys may be used.

It is possible that due to an alternative arrangement of the indicator tape the portion of indicator tape which has indicia may pass through other parts of the stapling device, other than the upper rear portion of the device. Consequently it will be understood that the viewing area can take many forms and that any convenient location for the viewing area which allows a view of the indicator tape is also encompassed by the present invention. It is envisaged that any convenient location, preferably towards the rear of the stapling device, may be used for the viewing area. For example a viewing area defined by a window may be located in a rear portion or in the base of the stapling device as alternatives to the actuating arm. Furthermore the size and shape of the viewing area may be altered to any convenient configuration which allows the user to see the relevant part of the indicator tape.

The nature of the indicia on the indicator tape could vary from the green and red colouration, with the change between green and red indicating a depletion of staples, which is shown in the exemplified embodiment. Any other indicia which can provide a user with a visual signal capable of representing the number of staples remaining in the staple magazine would be appropriate for use in the present invention, such as, for example, some form of graduated markings or the like.

Whilst the preferred embodiment comprises an indicator tape made of plastics material, it is also envisaged that other materials could be used, such as, for example, maleable metal or the like.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A stapling device comprising:
a staple magazine configured to receive a strip of staples and having an ejection opening;
a staple feeder biased towards the ejection opening so as to bear against an end of a strip of staples in the magazine and urge the strip towards the ejection opening, the feeder thus being configured to move towards the ejection opening, under said bias, as the number of staples in the strip depletes; and
the device further comprising an indicator tape attached to the staple feeder and having indicia, wherein the indicator tape is configured to allow movement of the indicia past a viewing area to provide a visual indication representative of the number of staples remaining in the staple magazine, and wherein one end of the indicator tape is wound onto a reel.

2. A stapling device according to claim 1, wherein the indicator tape is biased away from the ejection opening, under a force which is weaker than the force acting to bias the feeder towards the ejection opening.

3. A stapling device according to claim 2, wherein the indicator tape is biased by a spring.

4. (canceled)

5. A stapling device according to claim 3, wherein the indicator tape is biased via a clock spring.

6. (canceled)

7. A stapling device according to claim 1, wherein the indicator tape passes around one or more pulleys.

8. A stapling device according to claim 1, wherein the viewing area is defined by a window in the stapling device.

9. A stapling device according to claim 8, wherein the window is located in an actuating arm of the stapling device.

10. A stapling device according to claim 1, wherein the indicia comprise portions of colour on the indicator tape.

11. A stapling device according to claim 1, wherein the indicator tape is made from plastics.

12. A stapling device according to claim 1, wherein the indicator tape is made from malleable metal.

13. A stapling device according to claim 1, wherein the indicator tape is elastically deformable.

14. (canceled)

15. (canceled)

16. (canceled)

17. (canceled)

18. A stapling device according to claim 3, wherein the reel is biased by said spring in a direction effective to wind the indicator tape.

19. A stapling device according to claim 1, wherein the indicator tape is biased via a clock spring.

20. A stapling device according to claim 19, wherein the reel is biased by said spring in a direction effective to wind the indicator tape.
